(19) United States
(12) Patent Application Publication
(10) Pub. No.: US 2006/0203862 A1
(43) Pub. Date: Sep. 14, 2006

(54) Method and apparatus for CWDM optical transmitter with extended operating temperature range

(75) Inventors: Adi Bonen, Los Gatos, CA (US); Hoa Nguyen, San Jose, CA (US); LiPing Chen, San Jose, CA (US); Wei Huang, San Jose, CA (US)

Correspondence Address: MORRISON & FOERSTER LLP, 755 PAGE MILL RD, PALO ALTO, CA, 94304-1018, US

(73) Assignee: Harmonic Inc., Sunnyvale, CA (US)

(21) Appl. No.: 11/078,971

(22) Filed: Mar. 10, 2005

(51) Int. Cl. H01S 3/04

(52) U.S. Cl. 372/34

(57) ABSTRACT

An optical transmitter for coarse wavelength division multiplexed (CWDM) optical communication systems uses a conventional laser (e.g. laser diode) and in addition a heater element is provided thermally coupled to the laser. A thermal sensor and associated control circuit drive the heater so as to control the power consumed by the heater to assure that the laser's temperature is not lower than a predetermined minimum working temperature. When the sensed laser temperature is above this predetermined minimum temperature, the control circuit turns off the heater. The total operating range of the transmitter in terms of ambient temperature is thus extended beyond its inherent operating range by the maximum laser temperature rise created by the heater. This allows a CWDM optical transmitter with the heater and control circuitry to be used in outdoor applications where a wide ambient temperature range is required.

### FIELD OF THE INVENTION

This invention relates to communications and more specifically to optical communications and more specifically to laser transmitters used in coarse wavelength division multiplexed optical communications systems.

### BACKGROUND

Optical communications are well-known; this field typically involves transmitting light (optical) signals over optical fiber. A typical application is, for instance, a cable television system, but optical communications are also suitable for telephony and data communications. Optical communications typically use a technology called wavelength division multiplexing (WDM) wherein a number of separate optical links, each with its own optical wavelength, are multiplexed into one light stream transmitted on a single optical fiber. Such WDM systems utilize wavelength specific transmitters, multiplexers and (near the receiver) demultiplexers, the multiplexers and demultiplexers including wavelength specific optical filters. One form of WDM called dense wavelength division multiplexing (DWDM) involves transmitting signals of many tightly spaced wavelengths on the same fiber and allows use of optical amplifiers. DWDM is especially useful for long haul systems due to the possible use of optical amplification. DWDM transmitters have a typical bit rate of up to 10 gigabits per second. DWDM transmitters usually require the use of cooling for the laser in the optical transmitter. Typically the laser is thermally coupled to a thermoelectric cooler (TEC) which can actively heat and cool the laser. The TEC is typically located inside the laser's package. There is also present sophisticated control circuitry intended to maintain the laser temperature at a constant predetermined temperature such that its wavelength is not affected by changes in external (ambient) temperature. The required TEC components, the associated control circuitry, and their calibration substantially increase cost of the resulting DWDM transmitter.

Therefore, the communications industry developed coarse wavelength division multiplexing (CWDM) transmitters which also allow use of multiple wavelength transmissions on the same optical fiber. CWDM is generally a lower cost alternative to DWDM and is especially useful for shorter haul (less than 80 kilometer) optical transport. Typically, due to a smaller possible number of wavelengths, CWDM systems have a much lower bit rate capacity. Additionally, the cost of the CWDM transmitter is substantially lower than that of a DWDM transmitter. CWDM transmitters also typically use significantly less electric power and thereby exhaust significantly less heat than do DWDM systems. The chief difference is that in a CWDM system, the wavelength separation between each wavelength transmitted on the single optical fiber is significantly greater than in a DWDM system, by approximately a factor of 12.5 to 50. Another way to characterize the difference between DWDM and CWDM is that DWDM typically has 0.4, 0.8, or 1.6 nanometer wavelength spacing between channels whereas CWDM has a 20 nanometer wavelength spacing between channels. Hence, while DWDM systems multiplex a larger number of individual wavelength channels onto one fiber by providing relatively small separations between each channel, CWDM systems have significantly greater interchannel spacing and carry fewer channels. The ITU (International Telecommunications Union) has defined standards for CWDM to allow operation over a limited laser temperature range. To define the inter-channel spacing of 20 nanometers (nm) in conjunction with currently available optical filters, the ITU allows a maximum pass band window of approximately 14 nm wavelength, to which the laser output wavelength must correspond. A laser's output wavelength at room temperature (25° C.) is dependent on its intrinsic wavelength accuracy which is normally accurate to approximately ±2 nm for high grade lasers and ±3 nm for lower grade lasers. In addition, the laser wavelength changes with temperature due to a well understood physical phenomena, resulting in the wavelength drifting about 0.1 nm for every 1° C. change in laser temperature. The directly modulated lasers used in both CWDM and DWDM systems are typically distributed feedback lasers of the well known type which are commercially available from a number of vendors. The direct modulation applies the information signal to be carried, which is for instance that of a television channel, to directly modulate the laser's optical signal (light beam).

Present FIG. 1 shows a CWDM optical communications system of the type well known in the field. It includes in this case just two optical transmitters 10 and 12 although typically more transmitters would be present in an actual system, there being one transmitter per channel (wavelength). Each optical transmitter 10 and 12 includes a laser outputting an optical signal. The conventional CWDM multiplexer/filter 14 includes a set of optical filters each of which is a pass band filter and passes one particular relatively narrow pass band, typically as described above having a 20 nm wavelength spacing between channels and each channel having a 14 nm bandwith. The multiplexer/filter 14 thus includes a number of corresponding optical filters of the type well known in the field and which are commercially available. A device 14 with a single such filter is also referred to as an optical add/drop multiplexer (OADM). The multiplexer/filter 14 is connected by a span of optical fiber 18, typically up to 80 kilometers long, to, at the receiver end, CWDM demultiplexer/filter 22 which essentially contains the same type of filter components as the multiplexer/filter 14. In this case the demultiplexer 22 separates (filters) the optical signal into two distinct wavelengths each of which is applied respectively to receivers 26, 28. In this case transmitter 10 transmits a signal to be detected by receiver 26 and transmitter 12 transmits a signal to be detected by receiver 28.

FIG. 2 shows the 14 nm pass band typical of CWDM systems as defined by the ITU. As shown, the optical signal occupies the 14 nm pass band having both the minimum laser wavelength and a maximum laser wavelength with a nominal central laser wavelength. Typically the nominal laser wave length is in the range of 1270 to 1610 nm. As shown, the maximum laser wave length at 25° C. is separated by 6 nm wavelength from the minimum laser wavelength at 25° C., where 25° C. represents (nominal) room temperature. There is substantial optical filter attenuation both above and below the 14 nm pass band.

Hence the 14 nm optical filter window shown in FIG. 2 typically allows for a 100° C. range of operation for the above-mentioned type high grade lasers, and a 80° C. range of operation for low grade lasers. In both cases, that operating temperature range is sufficient for most indoor transmitter operation conditions, where the laser transmitter is located within a building. Hence, in such indoor applications, the required transmitter ambient temperature range is typically 0° to 50° C. which leads to a slightly wider laser temperature operating range of approximately 0° to 70° C. However, most outdoor applications, as is typical in cable television, require transmitter operation over a wider temperature range. This is because outdoor transmitters are exposed to extreme winter cold and extreme summer heat, especially when they are in the sun. This is especially a problem in North America with its wide temperature ranges. Note that in more temperate climates such as in Western Europe, a narrower outdoor operating temperature range is more common. However, in North America, a typical temperature operating range for a laser transmitter in an outdoor environment is approximately −40 to −85° C. This includes approximately 25° C. of heating caused by the laser operation itself plus heating due to the sun. Thus, presently outdoor transmitters using a CWDM laser can only be used in situations in which the expected temperature operating range is relatively narrow, such as Western Europe or Japan and hence are not suitable for North America.

At the present time, it is not possible to reliably use CWDM transmitters in outdoor installations in places such as North America, Eastern Europe, or Russia having wide annual temperature extremes. Of course, it would be desirable to make CWDM technology available in such areas due to its relatively low cost.

### SUMMARY

In accordance with this disclosure, an optical (laser) transmitter suitable for use in a CWDM system has its effective operating temperature extended so as to make it suitable for use in outdoor environments having a very large temperature range such as for instance −40° to 85° C. This is done by relatively inexpensive modifications to a conventional CWDM transmitter and so the resulting transmitter is still substantially less expensive than a DWDM transmitter. This is done by heating the laser, using in one version a low cost heater mounted external to the conventional laser package. A heat sink is mounted to the laser package and an electrical power consuming device (heater) is also mounted to the heat sink. No electric (active) cooling need be provided. A thermal sensor is also mounted to the heat sink. A control circuit is electrically connected between the heater and the thermal sensor such that it controls the power consumed by the heater. This assures that the laser operating temperature is never lower than a predetermined minimum temperature. When the laser temperature is detected as being above this predetermined minimum temperature, the control circuit turns the heater off. Of course, when the laser temperature is below the predetermined minimum temperature, the control circuit turns on the heater and provides sufficient current thereto so as to achieve the predetermined minimum temperature. Hence, the total operating temperature range of the transmitter is extended beyond the inherent 80° C. or 100° C. range of respectively low grade or high grade lasers as mentioned above, due to the maximum laser temperature rise provided by the heater. This advantageously allows use of the transmitter in an outdoor environment over a greater temperature range, as extended by the amount of heating provided by the heater.

The term “laser” here also refers to a laser diode. Such devices are commercially available in a conventional housing with a plurality of external electrical connectors (pins). The package is usually all or partly metal, and so is thermally conductive. While in one embodiment the heater is co-mounted to a heat sink (thermally conductive member) with the packaged laser, this is not limiting, and the heater may be located inside the laser package.

Also provided in one version is in a “cold start” control circuit to make sure that the optical transmitter when first powered up rapidly achieves the predetermined minimum temperature while avoiding undesirable temperature fluctuations during laser steady state operation. This feature is used primarily when the optical transmitter is being serviced or adjusted and the laser is thereby powered down and must be re-started, or when a power failure has interrupted the operation of the transmitter.

### BRIEF DESCRIPTION OF THE DRAWINGS

FIG. 1 shows a CWDM optical communication system both of the type known in the art and in which improvements in accordance with this disclosure may be present;

FIG. 2 shows the 14 nm pass band of a typical CWDM optical signal;

FIG. 3 shows a block diagram of an optical transmitter in accordance with this disclosure;

FIG. 4 shows an optical pass band similar to that of FIG. 2 but as extended in accordance with this disclosure.

FIG. 5 shows detail of the control circuit of the FIG. 3 optical transmitter.

### DETAILED DESCRIPTION

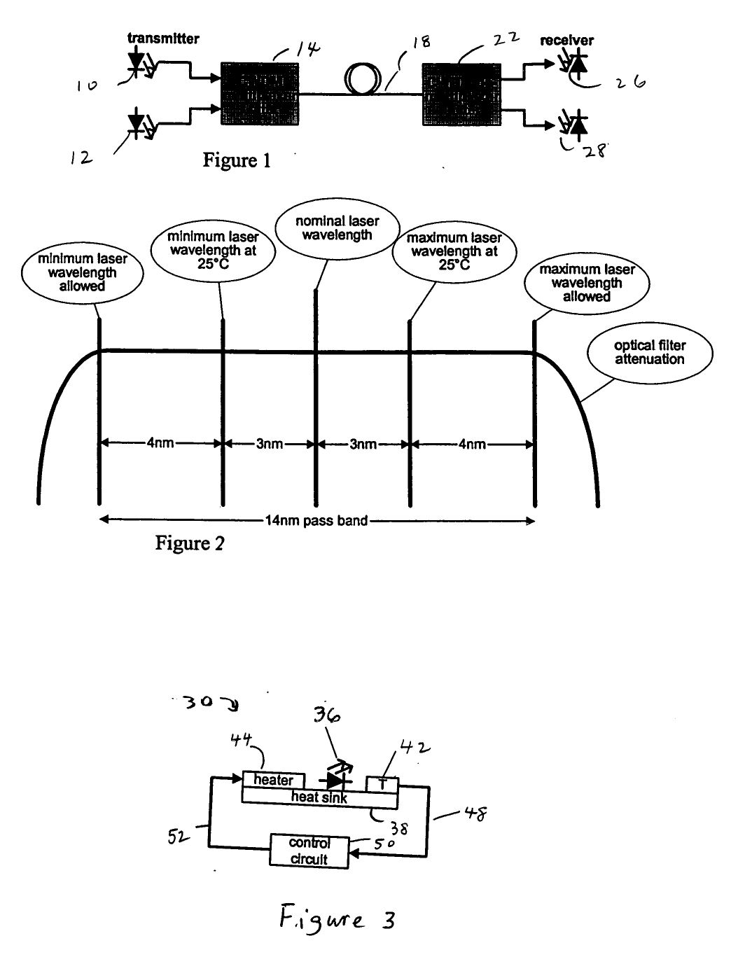

FIG. 3 shows an optical transmitter 30 in accordance with this disclosure. This is intended to be used as a replacement for each of optical transmitters 10, 12 in a system such as that of FIG. 1. In most respects, optical (laser) transmitter 30 is a conventional CWDM transmitter as described above. Optical transmitter 30 may be part of an optical transceiver also including a conventional receiver section (not shown). The remainder of the system of FIG. 1 when used with optical transmitter 30 of FIG. 3 is conventional; no special components are needed at the receiver end. However, as mentioned below, there may be some associated changes in the design parameters of the multiplexer/filter 14 and demultiplexer/filter 22 of the FIG. 1 system.

The FIG. 3 transmitter 30 includes a conventional distributed feedback (DFB) directly modulated laser 36 of the type well known in the field. Also provided conventionally is a power supply and other auxiliary circuitry (not shown) of the type standard in optical transmitters. Conventional laser 36 (in most cases, the packaged laser) is mounted on a heat sink 38 which is a thermally conductive structure. Heat sink 38 may be conventionally associated with a circuit board or similar mounting for carrying the conventional circuitry associated with a laser 36. Also mounted on heat sink 38 is a suitable conventional thermal sensor 42. This particular configuration is not the only one suitable; however, thermal sensor 42 is in suitable thermal contact with laser 36 so as to sense the operating temperature of laser 36. Also thermally associated with laser 36 is a heater element 44. As shown, heater 44 is mounted on the heat sink but again this particular configuration is only illustrative.

Heater 44 is for instance a standard type resistance heater, or in another version a field effect transistor (FET) of the type normally referred to as a power transistor which sinks a relatively large amount of electric current and hence generates a significant amount of heat. An advantage of using a field affect transistor is that it is easily controlled by a gate current and hence the control circuitry associated therewith is relatively simple. In this case, the control circuit 50 is shown connected via a feedback path (conductor) 48 to the thermal sensor 42 and by a control path 52 to the heater 44. As indicated, if the heater 44 includes a field effect transistor, path 52 carries a control (gate) voltage to control the field effect transistor in heater 44. The FET also has a voltage source supply (not shown) coupled to its source/drain terminals. Hence in FIG. 3, the heater 44 is external to the package of laser 36, and no active cooling function needs be provided.

Control circuit 50 in one embodiment is an analog circuit of the type well known in the electrical engineering field for controlling a heater in response to a sensed temperature. In another embodiment, control circuit 50 is embodied in a suitably programmed microprocessor or a microcontroller and associated driver circuits.

As explained above, in operation control circuit 50 operates to effectively extend the range of ambient operating temperature of laser 36. The control circuit 50 is such that it controls the power consumed by the heater 44 to assure that the operating temperature of the laser is not lower than a predetermined minimum working temperature. When the laser temperature is sensed by sensor 42 is above the predetermined minimum temperature, control circuit 50 turns off heater 44, that is does not supply any electric power thereto. Otherwise, heater 44 is sourced with suitable power (current) via a control signal on control line 52 so as to maintain the laser temperature to at least the predetermined working temperature.

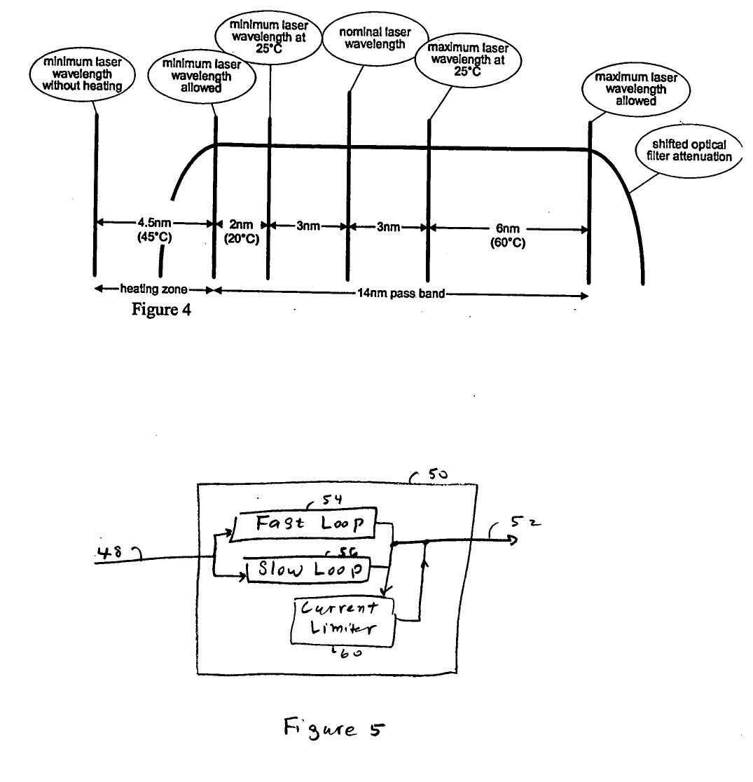

The resulting effect on the light beam output from laser 36 is shown in FIG. 4 which corresponds to FIG. 2. As shown in the left hand portion of FIG. 4 there is a heating zone, in this case over a temperature range of 45° C. during which the heater 44 is in operation. The heating zone is such that the wavelength of the light beam output by laser 36 is within the 14 nm pass band. Thus, the minimum output laser wavelength allowed is on the right hand portion of the heating zone. As seen from FIG. 4, either the fundamental (room temperature) laser wavelength, or the center wavelength of the optical filter associated with the laser, is shifted (compared to FIG. 2) such that the nominal wavelength of the laser operating at 25° C., for instance, is not at the center of the optical filter pass band. For instance, the filter in the CWDM multiplexed/filter 14 outputs a pass band that is shifted in terms of wavelength compared to that of a conventional system such that the filter is suitable for a conventional laser 36 operating at temperatures in the range 5° to 85° C. As shown in FIG. 4, the control circuit 50 is set so that the laser temperature is always above 5° C. and hence a 45° C. temperature rise from the heater 44 ensures that the optical transmitter operates at as low as −40° C. ambient temperature. Hence there is typically a different pass band for the optical filter in the CWDM multiplexer/filter associated with the FIG. 3 optical transmitter than with an unheated conventional CWDM optical transmitter. However, since these optical filters are commercially available with a large variety of pass bands, providing a slightly different pass band for the optical filter is easily accomplished technically. Note that transmitter 30 and multiplexer 14 in certain embodiments need not be separate devices but may be combined into one apparatus.

An additional feature in one embodiment is provided in control circuit 50 as shown in greater detail in FIG. 5. The input line 48 carrying the signal from the thermal sensor 42 carries this signal to control circuit 50 whereas the output signal, which is the control signal for the heater 44, is shown on line 52 similar to FIG. 3. The internal circuitry of control circuit 50 includes three elements, the first of which is a fast control loop 54, the second of which is a slow control loop 56, and the third of which is a current limiter circuit 60. Each of these is conventional and in one embodiment they are embodied in a set of analog components, each of circuits 54, 56 and 60 including an operational amplifier with conventional associated resistors and capacitors. The values of the resistors and capacitors depend on the particular characteristics of the heater 44, in terms of how much heat it needs to produce, which of course depends on the operating characteristics of laser 36 and on the desired operating temperature range.

This particular control circuit 50 thereby has additional complexity, referred to above, which provides a solution to the “cold start” problem. This is a problem identified by the present inventors. This problem involves the time that elapses from the time the transmitter is turned on, that is powered up, at a cold temperature until the control circuit 50 can bring the temperature of the laser 36 up to the required predetermined minimum working temperature. This time is referred to here as a cold start duration. During the cold start duration, the transmitter 30 is not operational since it will not be transmitting an optical signal within the desired pass band of FIG. 4. The present inventors have recognized a trade-off between the maximum power consumed by the heater 44, the thermal mass of the laser 36 and the heater 44, and the cold start duration. The present inventors have also recognized that while a fast acting control process can shorten the cold start duration, this may also cause undesirable temperature fluctuations during later steady state operation. Of course, the transmitter of FIG. 3 is only occasionally powered up; in normal operation, it is in its steady state operation mode. A cold start typically occurs when the system is first installed or after it has been shut down either due to power failure or for maintenance or adjustment.

The stability of temperature during steady state operation has been identified as important. Hence the control circuit 50 of FIG. 5 determines when rapid heating is required during cold start and when a steady state condition is reached such that the desired short cold start duration does not impede temperature stability during the steady state operation. Control circuit 50 (see FIG. 5) includes two control loops, the fast acting control loop 54 and the slow acting control loop 56 each including an operational amplifier. Each loop 54, 56 receives as an input signal the same temperature sensing signal on line 48. However, the values of associated resistors and capacitors of the fast loop 54 and slow loop 56 are different, so that the R,C values for the slow acting control loop are relatively much higher. The slow loop 56 is associated with the steady state mode operation of the device and sets the heater control signal on line 52 when the temperature sensor 42 indicates that the temperature is not too far from the desired temperature. In contrast, the fast loop 54 provides the heater control signal on line 52 during the cold start duration mode and causes a greater amount of current to be sourced to heater 44, but only during the cold start duration.

The FIG. 5 control circuit is not required in all embodiments and a simpler control circuit (with only one operating mode) is used if the cold start duration is not considered to be a problem in any particular system. Also provided in FIG. 5 is a conventional current limiter circuit 60 which conventionally includes an operational amplifier and several diodes to make sure that the amount of current supplied on line 52 does not exceed some predetermined maximum value.

This disclosure is illustrative and not limiting; further modifications will be apparent to those skilled in the art in light of this disclosure and are intended to fall within the scope of the appended claims.

What is claimed as new and desired to be protected by Letters Patent of the United States is:

1. An optical transmitter comprising:
a laser outputting an optical beam for coarse wavelength division multiplexed communications;
a support for the laser;
a heater thermally coupled to the laser; and
a temperature control adapted to sense a temperature of the laser and in response control the heater.

2. The optical transmitter of claim 1, wherein the temperature control includes a sensor coupled to a control circuit, the control circuit also being coupled to the heater.

3. The optical transmitter of claim 1, wherein the heater includes at least one of a field effect transistor or a resistance element.

4. The optical transmitter of claim 1, wherein the support is a thermally conductive member on which the heater is mounted.

5. The optical transmitter of claim 1, wherein the temperature control maintains a temperature of the laser above a first predetermined temperature.

6. The optical transmitter of claim 5, wherein the temperature control turns the heater off when the temperature of the laser is above a second predetermined temperature greater than the first predetermined temperature.

7. The optical transmitter of claim 1, wherein the temperature control operates in two modes dependent on a temperature of the laser, a first mode sourcing a greater electric current to the heater and a second mode sourcing a lesser electric current to the heater.

8. The optical transmitter of claim 7, the first mode being when the temperature of the laser is relatively low and the second mode being when the temperature of the laser is relatively high.

9. The optical transmitter of claim 2, wherein the control circuit includes two control loop circuits each having a control terminal coupled to the sensor and each having an output terminal coupled to the heater, and further including an electric current limiter coupled to the heater.

10. The optical transmitter of claim 1, the support being a heat sink.

11. The optical transmitter of claim 1, the laser being a laser diode.

12. A method of operating an optical transmitter, comprising the acts of:
sensing a temperature of a laser of the transmitter;
controllably heating the laser in response to the sensed temperature; and
outputting from the laser an optical beam for coarse wavelength division multiplexed communications.

13. The method of claim 12, further comprising thermally coupling a sensor to the laser for sensing the temperature.

14. The method of claim 12, wherein the heating is provided by one of a field effect transistor or a resistance element.

15. The method of claim 12, wherein the heating maintains a temperature of the laser above a first predetermined temperature.

16. The method of claim 15, wherein the heating turns off when the temperature of the laser is above a second predetermined temperature greater than the first predetermined temperature.

17. The method of claim 12, wherein the heating operates in two modes dependent on the temperature of the laser, a first mode sourcing a greater electric current for the heating and a second mode sourcing a lesser electric current for the heating.

18. The method of claim 17, the first mode being when the temperature of the laser is relatively low and the second mode being when the temperature of the laser is relatively high.

19. The method of claim 12, further including limiting an electric current for the heating.

20. The method of claim 1, the laser being a laser diode.
